(19) United States
(12) Patent Application Publication
(10) Pub. No.: US 2025/0271539 A1
(43) Pub. Date: Aug. 28, 2025

(54) RADAR SENSOR DEVICE AND METHOD FOR OPERATING A RADAR SENSOR DEVICE

(71) Applicant: Robert Bosch GmbH, Stuttgart (DE)

(72) Inventors: Tim Poguntke, Kempten (DE); Werner Soergel, Pforzheim (DE); Thomas Binzer, Ingersheim (DE)

(21) Appl. No.: 18/856,992

(22) PCT Filed: May 2, 2023
(86) PCT No.: PCT/EP2023/061498

§ 371 Date: Oct. 15, 2024

(30) Foreign Application Priority Data
Jun. 27, 2022 (DE) 10 2022 206 451.8

(51) Int. Cl. G01S 7/02; G01S 13/931

(52) U.S. Cl. CPC G01S 7/0232; G01S 13/931

(57) ABSTRACT

A radar sensor device. The radar sensor device includes at least one radar sensor and a controller which is connected to the at least one radar sensor and is designed to control the process of generating a transmission signal and the process of sampling a received signal of the radar sensor. The transmission signal is a periodically repeated and linearly frequency-modulated signal. The center frequency and/or ramp gradient and/or pulse repetition rate of the transmission signal and/or the number of frequency ramps per measurement cycle and/or pauses between measurement cycles can be adjusted. The controller is designed to detect pulse interference occurring in the sampled received signal and to calculate the frequencies of the transmission causing the interference.

### FIELD

The present invention relates to a radar sensor device and to a method for operating a radar sensor device.

### BACKGROUND INFORMATION

Radar sensors can play an important role in increasing the degree of automation of vehicles, and the number of radar sensors per vehicle is expected to continue to rise. In common applications, a large number of vehicles can already be equipped with driver assistance functions that are realized with the aid of radar sensors. A radar sensor emits a modulated electromagnetic wave and determines the distances and relative speeds of various reflection points in the surrounding environment of the moving vehicle from the received reflection, which is delayed and Doppler frequency-shifted.

The current series sensors of different vehicles use independent modulations and are usually not coordinated with each other, as a result of which at the same time the probability increases that the signals from the radar sensors will interfere due to superposition of the electromagnetic waves and reduce the signal quality.

Due to the increasing number of radar sensors within a vehicle, the radar sensors are operated in a coordinated manner to reduce the interference of the radar sensors from a vehicle. For this purpose, the hardware of the radar sensors is synchronized.

In M. B. Alabd, B. Nuss, C. Winkler and T. Zwick, “Partial Chirp Modulation Technique for Chirp Sequence based Radar Communications,” 2019 16th European Radar Conference (EuRAD), 2019, pp. 173-176, an application of a modulation method is described.

European Patent Application No. EP 3 572 828 A1 describes a combined radar and communications system.

### SUMMARY

The present invention provides a radar sensor device and a method for operating a radar sensor device.

Preferred developments of the present invention are disclosed herein.

The present invention provides a radar sensor device and a method for operating a radar sensor device, wherein an operation of the sampling of a radar sensor at specific times and signal curves can be better selected. Here, sampling refers to the reception of high-frequency signals emitted by the radar sensor, which are characterized as linear frequency modulation, i.e. frequency ramps over time. In the receiver, the signal received by the antenna system is mixed down into the baseband with the transmitted signal and then sampled with an analog-to-digital converter.

According to an example embodiment of the presnet invention, the radar sensor device comprises at least one radar sensor; and

a controller which is connected to the at least one radar sensor and is configured to apply a transmission signal to the radar sensor and to carry out a sampling sequence on the radar sensor, wherein a specific time portion of the transmission signal and/or of a received signal at the radar sensor can be selected for the application of the sampling sequence.

According to an example embodiment of the present invention, the radar sensor device comprises at least one radar sensor, and a controller which is connected to the at least one radar sensor and is designed to control a generation of a transmission signal and a sampling of a received signal of the radar sensor, wherein the transmission signal is a periodically repeated and linearly frequency-modulated signal, and wherein a center frequency and/or ramp gradient and/or pulse repetition rate of the transmission signal and/or a number of frequency ramps per measurement cycle and/or pauses between measurement cycles can be adjusted, and the controller is designed to detect pulse interference occurring in the sampled received signal and to calculate the frequencies of the transmission causing the interference.

According to a preferred embodiment of the radar sensor device of the present invention, the causing transmission relates to another radar sensor and is emitted by it.

According to a preferred example embodiment of the radar sensor device of the present invention, it comprises a reference control unit and a reference sensor, which is designed to emit a reference transmission signal and the controller is connected to the radar sensor and with which the transmission signal of the radar sensor can be synchronized with the reference transmission signal of the reference sensor with regard to a transmission and sampling by the controller.

According to a preferred example embodiment of the radar sensor device of the present invention, the transmission signal comprises a triangular signal.

According to a preferred example embodiment of the radar sensor device of the present invention, a reference unit, which comprises the reference control unit and the reference sensor, and a further sensor unit, which comprises the controller and the radar sensor, are located in different vehicles.

With the (specific) sampling sequence, a received signal from the radar sensor can be evaluated and conclusions can be drawn about the distance and movement of an object. The sampling points and/or transmission points in frequency and time can advantageously be selected, for example at a specific time and frequency of the signal, for example also in their number and duration, and/or the like. The change in frequency can be a specific type of frequency curve at the selected sampling points, such as a portion where a signal ramp increases in frequency (e.g., linearly or nonlinearly) or decreases, or both.

Thus, the sign of the ramp steepness (ramp direction) can be changed during the sampling, or a sampling can be effected when the slope of the signal is as desired. Thus, sampling can also be selected for signal portions within a “chirp sequence” measurement cycle. A particular advantage is the simplicity of the method, as a result of which it can be applied directly without affecting the subsequent signal processing. The desired signal can be specified and the portions to be sampled can be selected.

The ramp direction within a measurement cycle can be chosen arbitrarily, which can offer different potentials for radar sensors. In this way, the use of triangular modulation can be achieved with almost constant signal processing, as a result of which no return jumps in the phase-locked loop are necessary anymore and the ramp repetition rate can be increased. By omitting the return jump, the interference is reduced, or it is not necessary to switch off the transmitter amplifier. Furthermore, a synchronization of cooperative sensors can be effected, as a result of which transmissions can also be wirelessly coordinated to avoid interference. Furthermore, the choice of ramp direction can enable communication between radar sensors depending on an information data stream (e.g., a sequence of 0 and 1 symbols). This can be used to coordinate the communicating radar sensors and exchange information.

According to a preferred example embodiment of the radar sensor device of the present invention, it comprises a reference sensor, which emits a reference transmission signal and/or uses a reference sampling signal, and the controller, which controls the reference transmission and reference sampling signal with regard to time, frequency and ramp direction.

Furthermore, coordination of the operation of a plurality of radar sensors or synchronization of the operation or sampling of the radar sensors can be improved.

According to a preferred embodiment of the radar sensor device, the predetermined transmission signal comprises a triangular signal, advantageously as a function of the frequency of the transmission signal over time.

The transmission signal can advantageously be variable and can therefore be adapted/synchronized to the reference signal and/or the reference sampling rate.

According to a preferred embodiment of the radar sensor device, sampling can be carried out during a signal ramp with increasing frequency of the transmitted signal and/or the received signal and/or during a signal ramp with decreasing frequency of the transmitted signal and/or the received signal, and/or the slope of the signal ramp can be selected by means of the controller.

According to a preferred embodiment of the radar sensor device, it comprises a plurality of radar sensors which can be installed in the same vehicle or in particular in different vehicles, and by means of which the transmission signal and the sampling sequence at the radar sensors can be synchronized with the reference sampling signal and with the reference transmission signal.

In addition to synchronization, communication between the radar sensors can be effected via the air interface.

According to the present invention, the method for operating a radar sensor device comprises providing a radar sensor device according to the present invention comprising at least one radar sensor and one reference sensor; detecting the pulse interference generated by the transmission of the reference sensor in the received signal of the radar sensor and calculating the transmission frequencies of the transmission of the reference sensor; controlling the radar sensor by means of the controller in such a way that by suitably adjusting the modulation parameters, in particular center frequency, ramp gradient, point in time of transmission, the detected frequency of the frequency generated by the reference sensor in the received signal of the radar sensor is constant.

According to a preferred example embodiment of the method of the present invention, a further synchronization of transmissions from the radar sensor is effected with the transmissions from the reference sensor; the control of the radar sensor is effected by means of the controller with a sequence of ramp gradients that is suitable for minimizing the duration of the amplitude-pulse disturbances and thus the interference.

According to a preferred example embodiment of the method of the present invention, a control of the radar sensor is further effected by means of the controller with a sequence of ramp gradients that is suitable for generating a sequence of amplitude pulse disturbances in the received signal of the reference sensor, which sequence transmits a message on the basis of a defined code book.

According to a preferred example embodiment of the method of the present invention, a minimization of the interference of the message at the radar sensor is further effected in conjunction with controlling the radar sensor by means of the controller with a sequence of ramp gradients that has a time offset to the transmissions from the radar sensor that is suitable in order to avoid or reduce interference generated by the reference sensor in the received signal of the radar sensor.

According to a preferred example embodiment of the method of the present invention, a minimization of the interference of the message at the radar sensor is further effected, in particular in conjunction with controlling the radar sensor by means of the controller with a sequence of ramp gradients that has a frequency offset to the transmissions from the reference sensor that is suitable in order to avoid or reduce the interference generated by the reference sensor in the received signal from the radar sensor.

According to a preferred example embodiment of the method of the present invention, the reference sensor, after synchronization and transmission of the messages from a plurality of radar sensors, transmits messages for coordinating the transmissions of the various radar sensors by transmitting a suitable ramp sequence, wherein the controllers of the radar sensors interpret the message according to a previously defined code book.

According to the present invention, the method for operating a radar sensor device comprises providing a radar sensor device according to the present invention; controlling the radar sensor with the transmission signal and carrying out the sampling sequence at the radar sensor, wherein a specific time portion of the transmission signal and/or of the received signal is selected for the application of the sampling sequence.

According to a preferred example embodiment of the method of the present invention, the sign of a ramp gradient of the transmitted signal and/or the received signal and/or the sampling sequence is selected according to a specification.

According to a preferred example embodiment of the method of the present invention, the reference sensor transmits the reference transmission signal, with which the second (or a further) radar sensor synchronizes its own transmission signal with the aid of the controller.

According to a preferred example embodiment of the method of the present invention, the reference sensor generates a reference transmission signal and/or a reference sampling signal, which, by a second sensor with its controller, synchronizes the transmission signal of the second sensor with the reference transmission signal of the reference sensor with regard to transmission and sampling.

The presented method of the present invention is easy to implement and can be directly applied in today's radar sensors. However, due to the existing separation between radiolocation services and communication in the regulation of today's radar frequency bands, the method also appears to be particularly suitable for future sensors in new frequency bands, e.g. above 100 GHz. The increased speed evaluation range means that the method confers advantages for the sensor itself, and through the reduced interference it also confers advantages for all radar sensors in use in the field.

The radar sensor device of the present invention can also be distinguished by the features and their advantages mentioned in connection with the method of the present invention, and vice versa.

Further features and advantages of embodiments of the present invention will become apparent from the following description with reference to the figures.

The present invention is explained in more detail below based upon the exemplary embodiments indicated in the schematic figures.

### BRIEF DESCRIPTION OF THE DRAWINGS

FIGS. 1A-1C show a schematic representation of a signal curve of frequency over time for the operation of a radar sensor device according to a comparative example, and according to two exemplary embodiments of the present invention.

FIG. 2 shows a block diagram of method steps of the method for operating a radar sensor device according to a further exemplary embodiment of the present invention.

FIGS. 3A and 3B shows a representation of an interference signal from fully synchronized radar sensors, and a deviation therefrom.

In the figures, identical reference signs denote identical or functionally identical elements.

### DETAILED DESCRIPTION OF EXAMPLE EMBODIMENTS

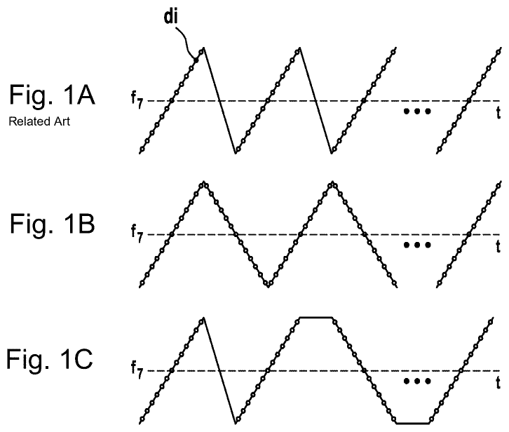

FIGS. 1A-1C show a schematic representation of a signal curve for operating a radar sensor device according to a comparative example, and according to two exemplary embodiments of the present invention.

In FIG. 1A, a ramp signal (transmission signal or received signal) of a frequency f is shown dependent on time t, which corresponds to a conventional chirp signal. Sampling can usually only be effected on the branch with descending frequency, via the sampling points di.

The related art can be assumed to be a “chirp sequence” modulation method in sawtooth form as outlined in FIG. 1A. FIG. 1A shows the modulation scheme and the indicated sampling points in time di on the rising ramp of the frequency of the signal at the radar sensor. After two-dimensional sampling in the time and frequency direction, the distance (via time delay) and speed (via Doppler frequency shift) of radar targets can be determined (e.g., when the transmission and received signals are superimposed).

FIGS. 1B and 1C, on the other hand, follow an inventive approach according to which the “chirp sequence” modulation method can be used in an adapted form without affecting the radar signal processing. Instead, the application of the modulation can be improved and further application possibilities arise, e.g. for the synchronization or communication of cooperatively acting radar sensors. A typical chirp sequence radar uses the generated transmission signal (frequency ramps with frequency dependence f(t)) simultaneously as the input signal of the mixer in the reception path (homodyne principle). After the mixer, the received signal is low-pass filtered by an anti-aliasing filter (AAF) with cutoff frequency f_{AAF}. The sampling is then effected by the A/D converter.

Due to the homodyne principle, the frequency range sensitive to the reception of signals is effectively shifted with f(t).

The signs of individual ramps of a signal at the radar sensor can be changed within a measurement cycle. In other words, that ramp (or plurality of ramps) can be selected at which the frequency curve of the radar transmission signal can be effected according to a particular sequence with a positive or negative gradient, wherein pauses are also possible.

If the ramp direction is to be reversed without affecting the signal processing, the sampling of the frequency ramps must be adapted so that the sampled values correspond to the same instantaneous frequency of the ramp, i.e. have the same temporal step size of the sampling points, even with a ramp decreasing in frequency, as shown in FIG. 1B.

In a system of two radar sensors (reference sensor or first sensor and second sensor), the second sensor is now operated with a sequence complementary to the first sensor. That is, where the reference sensor uses a signal that increases in frequency over time, the second sensor uses a signal that decreases over time.

Both the first and second sensors detect the sampled values in the received signal that are affected by interference from other sensors.

Interference occurs due to the reception of high-frequency signals sent by other sensors. The interference appears as amplitude pulse interference in the sampled received signal. This pulse interference is assigned to a specific frequency in the receiver (FIGS. 3A and 3B).

In particular, the second sensor detects the sampled values that were disturbed (interfered with) by the signal of the first sensor as amplitude pulse interference. The sampled values of the interference of the signal of the first sensor with a fully synchronized second sensor (with a sequence complementary to the first sensor with regard to the ramp gradients) in the “chirp sequence” method of FIG. 1A are advantageously located, for each chirp, at the same frequency in the middle of the frequency range covered by the frequency ramp. In this case, the start times of the frequency ramps of the first sensor and the second sensor are synchronized.

The radar channel, i.e. the signals reflected from the objects, can be assumed to be constant over time with respect to their frequency in the baseband for the duration of the ramps (subportions for an ascending or descending ramp, for example); for ramps with the opposite direction, only the order of the sampling values must be reversed. The method has no influence on the subsequent signal processing.

Due to the lack of a return jump to the beginning of a rising ramp, as in FIG. 1A (the new sampling series starts again only at the rising ramp and the sampling values of the frequency jump back to the smallest value of the sampling in conventional methods, but in method steps according to the present invention such a return can be omitted), firstly the ramp repetition rate can be increased, as a result of which the clearly measurable speed is increased. Secondly, this also reduces the interference potential and eliminates the need to switch off the transmitter amplifiers during the ramp return jump.

Furthermore, according to FIG. 1C, different sequences of rising, falling or resting regions of the signal can be used and follow one another, wherein this change in the ramp direction can be understood as a binary coding (e.g., a rising ramp corresponds to a 1, a falling ramp corresponds to a 0; see FIG. 1C with the code 1101).

The meaning assigned to this code can be used to transmit specific information. Here, it should be noted here that the time for the return jump should take into account that there is then a constant ramp repetition rate.

A coding the ramp direction in this way can also be used for the transmission of data between the radar sensors. Thus, after synchronization between a first and a second sensor has been effected, the temporal position of the pulse interference can be used to recognize whether the received interference signal is a rising or a falling ramp. The pulse interference in the received signal arises because the transmission signal of the first sensor with frequency dependence fₛ₁(t) crosses the frequency range of the second sensor sensitive for reception with the cutoff frequencies fₛ₂ (t) ±f_{AAF,2}. This signal is then visible as pulse interference in the sampled baseband signal.

The actual frequency of the interference can be calculated from the temporal position of the disturbed sampled values and fₛ₂(t). Subsequently, a decoding can be effected and correspond to a simple interference detection on the receiver side.

Pulse interference introduced by this communication can be limited to a few sampled values of the sampling sequence and can be corrected after decoding with conventional methods by suitable filtering or by replacing the disturbed sampled values with estimated values.

By assigning a meaning to the coded sequence of rising and falling ramps used by the first sensor as described above, optional information transmission can be effected, which can be used to improve the coordination of the radar sensors. For example, an ID (identification) for the function that the radar sensor performs or a prioritization with regard to the frequency bands are possible here; the transmission of a sensor type identifier, the center frequency and bandwidth used, etc. are also possible.

During communication, i.e. the transmission of data between the radar sensors, the synchronization of the frequency ramp sequences of both sensors can be adjusted (corrected or improved or aligned) by comparing the point in time of the expected interference pulse with the actual point in time of the interference pulse, and the difference can act as a controlled variable on a digital controlling of the signal output for the ramp sequence.

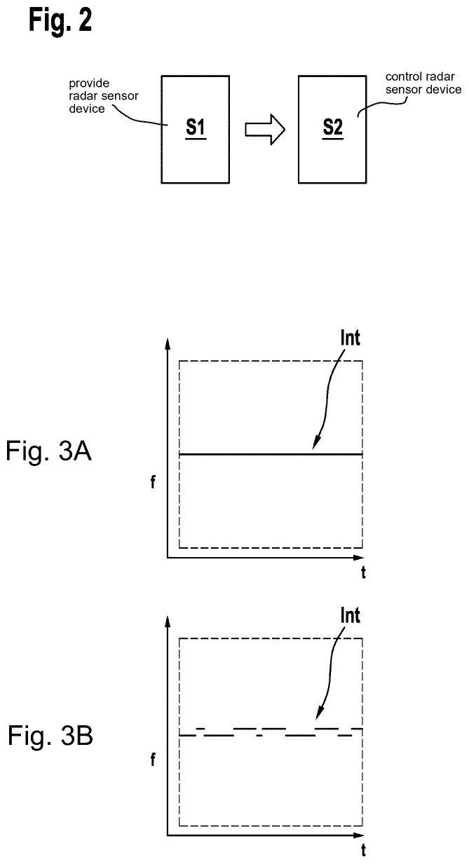

FIG. 2 shows a block diagram of method steps of the method for operating a radar sensor device according to a further exemplary embodiment of the present invention.

With the method for operating a radar sensor device, a provision S1 of a radar sensor device according to the present invention is effected; a controlling S2 of the radar sensor with the transmission signal is effected and a carrying out of the sampling sequence at the radar sensor is effected, wherein a specific time portion of the transmission signal and/or received signal is selected for the application of the sampling sequence.

FIGS. 3A and 3B show a representation of an interference signal of fully synchronized radar sensors and a deviation therefrom.

The method can be used for the synchronization of cooperative radar sensors. “Cooperative” can mean that the radar sensors are connected to each other in some way and/or that their functioning is coordinated. For this purpose, a reference sensor and a fixed bit sequence of the transmission and/or sampling signals can be determined in advance, wherein the reference sensor transmits and measures with this sequence, which is known to all the other sensors. The radar sensor to be synchronized uses the inverted code, for example 0100 in the case shown in FIG. 1C.

For the case in which the measurement cycles are perfectly synchronized, a pulse interference Int can occur in the center of all the ramps or baseband signals, which is shown in FIG. 3A. The line Int, which has constant frequency, shows that the pulse interference occurs at the same point (time or frequency connected by the ramp function) for all ramps of the second sensor. This “same point” is advantageously in the center of the second signal's own ramps. A complete synchronization in time and frequency has then been effected. The ramps of the first sensor and the second transmitter as an increment to each other advantageously intersect orthogonally, which corresponds to complete synchronization. In case of a deviation (as can be seen in FIG. 3B, i.e. an inclination of the ramps away from being orthogonal to each other), a correction of the ramps, and therefore synchronization, can take place.

If the interference is distributed in the direction of the upper and lower edges (i.e., towards larger and smaller frequency values), then synchronization is no longer present, which is shown in FIG. 3B, and can be detected using conventional interference detection methods. A length of the deviating pulses from the interference signal can be symbolic of an arbitrary behavior depending on the error (shift in time of the signal fS2(t) or stretch in time of the signal fS2(t)), which modifies the synchronization. A shifted bar in the signal Int can represent the frequency position of the pulse interference that has occurred, which in this case is not synchronized. The width of the individual interference pulses can be a measure of the ramp gradient of the interfering signal. This feature can also be used to classify the desired pulse sequence of the sensor to be synchronized, and the sequence of rising and falling ramps of the first sensor can be estimated from this. If the deviations of the interference maxima are recognized as control differences (if the bars Int are shifted from the horizontal center), synchronization becomes a simple control task. If interference occurs only sporadically, then the measurement cycles do not yet overlap and rough synchronization must be restored, for example by a delay.

For synchronization, the sensor to be synchronized switches to the original code (from the second sensor), i.e. the code that is optimal for its own function, and takes into account an additional delay, in particular a predetermined deviation from the ascertained reference signal; in addition, the sensors can then always transmit in the mutual pauses and not interfere with each other. After synchronization, the second sensor (e.g., its controller) can know when the first sensor is not transmitting and deliberately situates itself in this pause, where it can select the sequence of rising and falling ramps so that it is optimal for its measuring task.

For example, in the case of two sensors, sawtooth modulation can be used for synchronization (1111 and 0000). Due to the drifting apart of the temporal interference pulses (crossings of the signals in the time-frequency diagram when these are superimposed), deviations can be better detected when there are changes of ramp direction. The alignment of the ramp rate between the reference sensor and the radar sensor can be effected by inserting additional pauses in the ramp sequence. In addition, to synchronize multiple sensors, different codes can be used for the sensors to be synchronized.

The robustness of the described method can be increased by suppressing interference signals that do not originate from the sensor to be synchronized.

An assignment of the interference signals to individual sensors can be effected by ascertaining them and classifying them according to signal strength. For this purpose, it is advantageous to use only interference signals with sufficiently similar amplitudes.

For a signal filtering, a correlation of the interference pulse sequence with the expected code (e.g., through prior knowledge from a so-called code book, which prescribes the codes used by the communicating/cooperating sensors) can be used to filter out only the pulses desired for synchronization.

Due to the homodyne principle, the width of the individual interference pulses can be a measure of the ramp gradient of the interfering signal, since a frequency ramp of the first sensor generates wider interference pulses in the second sensor, the more similar its ramp gradient is to that of the first sensor. This feature can advantageously be used to classify the desired pulse sequence of the sensor to be synchronized.

Although the present invention has been completely described above with reference to preferred exemplary embodiments, it is not limited thereto, but can be modified in many ways.

1-11. (canceled)

12. A radar sensor device, comprising:
at least one radar sensor; and
a controller connected to the at least one radar sensor, the controller being configured to control a process of generating a transmission signal and a process of sampling a received signal of the radar sensor, wherein the transmission signal is a periodically repeated and linearly frequency-modulated signal: (i) a center frequency of the transmission signal, and/or (ii) a ramp gradient of the transmission signal, and/or (iii) a pulse repetition rate of the transmission signal, and/or (iv) a number of frequency ramps per measurement cycle, and/or (v) pauses between measurement cycles, can be adjusted, and the controller is configured to detect pulse interference occurring in the sampled received signal and to calculate frequencies of a transmission causing the interference.

13. The radar sensor device according to claim 12, wherein a causing the transmission relates to another radar sensor and the trainsmission is emitted by the other radar sensor.

14. The radar sensor device according to claim 12, further comprising:
a reference control unit, and a reference sensor which is configured to emit a reference transmission signal, wherein the controller is connected to the radar sensor and using the reference control unit, the reference sensor, the controller, and the radar sensor, the transmission signal of the radar sensor can be synchronized with the reference transmission signal of the reference sensor with regard to a transmission and sampling by the controller.

15. The radar sensor device according to claim 12, wherein the transmission signal includes a triangular signal.

16. The radar sensor device according to claim 14, wherein a reference unit which includes the reference control unit and the reference sensor, and a further sensor unit which includes the controller and the radar sensor, are located in different vehicles.

17. A method for operating a radar sensor device, comprising the following steps:
providing a radar sensor device including at least one radar sensor and one reference sensor;
detecting pulse disturbances generated by a transmission of the reference sensor in a received signal of the radar sensor and calculating transmission frequencies of the transmission of the reference sensor; and
controlling the radar sensor using a controller in such a way that by adjusting of modulation parameters including center frequency, ramp gradient, and point in time of transmission, the detected frequency of the frequency generated by the reference sensor in the received signal of the radar sensor is constant.

18. The method according to claim 17, wherein the controller is connected to the at least one radar sensor, the controller being configured to control a process of generating a transmission signal and a process of sampling a received signal of the radar sensor, wherein the transmission signal is a periodically repeated and linearly frequency-modulated signal: (i) a center frequency of the transmission signal, and/or (ii) a ramp gradient of the transmission signal, and/or (iii) a pulse repetition rate of the transmission signal, and/or (iv) a number of frequency ramps per measurement cycle, and/or (v) pauses between measurement cycles, can be adjusted, and the controller is configured to detect pulse interference occurring in the sampled received signal and to calculate frequencies of a transmission causing the interference

19. The method according to claim 17, further comprising:
synchronizing transmissions from the radar sensor with the transmissions from the reference sensor; and
controlling the radar sensor using the controller with a sequence of ramp gradients that is suitable for minimizing a duration of an amplitude pulse disturbances and thus the interference.

20. The method according to claim 17, further comprising:
controlling the radar sensor using the controller with a sequence of ramp gradients that is suitable for generating a sequence of amplitude pulse disturbances in the received signal of the reference sensor, the sequence transmitting a message based on a defined code book.

21. The method according to claim 20, further comprising:
minimizing interference of the message at the radar sensor in conjunction with controlling the radar sensor using the controller with a sequence of ramp gradients which has a time offset to transmissions from the reference sensor that is suitable to avoid or reduce interference generated by the reference sensor in the received signal of the radar sensor.

22. The method according to claim 20, further comprising:
minimizing interference of the message at the radar sensor, in conjunction with controlling the radar sensor using the controller with a sequence of ramp gradients which has a frequency offset to transmissions from the reference sensor that is suitable to avoid or reduce interference generated by the reference sensor in the received signal from the radar sensor.

23. The method according to claim 20, using which the reference sensor, after synchronization and transmission of the messages from a plurality of radar sensors, transmits messages for coordinating transmissions of the various radar sensors by transmitting a suitable ramp sequence, wherein controllers of the plurality of radar sensors interpret the message according to the predefined code book.
